(19) United States
(12) Patent Application Publication
(10) Pub. No.: US 2025/0119788 A1
(43) Pub. Date: Apr. 10, 2025

(54) PACKET DATA CONVERGENCE PROTOCOL HYBRID DELIVERY

(71) Applicant: QUALCOMM Incorporated, San Diego, CA (US)

(72) Inventors: Arnaud MEYLAN, San Diego, CA (US); Sri Sai KANDAKATLA, San Diego, CA (US); Atin KUMAR, San Diego, CA (US); Arun Prasanth BALASUBRAMANIAN, San Diego, CA (US)

(21) Appl. No.: 18/483,938

(22) Filed: Oct. 10, 2023

(51) Int. Cl. H04W 28/02; H04L 1/1607

(52) U.S. Cl. CPC H04W 28/0289; H04L 1/1607

(57) ABSTRACT

Various aspects of the present disclosure generally relate to wireless communication. In some aspects, a receiver may receive, at a packet data convergence protocol (PDCP) layer of the receiver, PDCP traffic including a plurality of packets associated with a bearer. The receiver may select, for each packet of the plurality of packets, between immediate delivery or ordered delivery based at least in part on one or more packet parameters associated with the packet. The receiver may deliver the plurality of packets in accordance with the selection between immediate or ordered delivery for each packet of the plurality of packets. Numerous other aspects are described.

### FIELD OF THE DISCLOSURE

Aspects of the present disclosure generally relate to wireless communication and to techniques and apparatuses for packet data convergence protocol (PDCP) hybrid delivery.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a receiver for wireless communication. The receiver may include one or more memories and one or more processors coupled to the one or more memories. The one or more processors may be configured to cause the receiver to receive, at a packet data convergence protocol (PDCP) layer of the receiver, PDCP traffic including a plurality of packets associated with a bearer. The one or more processors may be configured to cause the receiver to select, for each packet of the plurality of packets, between immediate delivery or ordered delivery based at least in part on one or more packet parameters associated with the packet. The one or more processors may be configured to cause the receiver to deliver the plurality of packets in accordance with the selection between immediate or ordered delivery for each packet of the plurality of packets.

Some aspects described herein relate to a method of wireless communication performed by a receiver. The method may include receiving, at a PDCP layer of the receiver, PDCP traffic including a plurality of packets associated with a bearer. The method may include selecting, for each packet of the plurality of packets, between immediate delivery or ordered delivery based at least in part on one or more packet parameters associated with the packet. The method may include delivering the plurality of packets in accordance with the selection between immediate or ordered delivery for each packet of the plurality of packets.

Some aspects described herein relate to a non-transitory computer-readable medium that stores a set of instructions for wireless communication by a receiver. The set of instructions, when executed by one or more processors of the receiver, may cause the receiver to receive, at a PDCP layer of the receiver, PDCP traffic including a plurality of packets associated with a bearer. The set of instructions, when executed by one or more processors of the receiver, may cause the receiver to select, for each packet of the plurality of packets, between immediate delivery or ordered delivery based at least in part on one or more packet parameters associated with the packet. The set of instructions, when executed by one or more processors of the receiver, may cause the receiver to deliver the plurality of packets in accordance with the selection between immediate or ordered delivery for each packet of the plurality of packets.

Some aspects described herein relate to an apparatus for wireless communication. The apparatus may include means for receiving, at a PDCP layer of the apparatus, PDCP traffic including a plurality of packets associated with a bearer. The apparatus may include means for selecting, for each packet of the plurality of packets, between immediate delivery or ordered delivery based at least in part on one or more packet parameters associated with the packet. The apparatus may include means for delivering the plurality of packets in accordance with the selection between immediate or ordered delivery for each packet of the plurality of packets.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example of an end-to-end data path for data associated with a UE, in accordance with the present disclosure.

FIG. 4 is a diagram illustrating an example of packet data convergence protocol (PDCP) ordered delivery, in accordance with the present disclosure.

FIG. 5 is a diagram illustrating an example of PDCP out of order delivery (OOD), in accordance with the present disclosure.

FIGS. 6-7 are diagrams illustrating examples associated with PDCP hybrid delivery, in accordance with the present disclosure.

FIG. 8 is a diagram illustrating an example process performed, for example, at a receiver or an apparatus of a receiver, in accordance with the present disclosure.

FIG. 9 is a diagram of an example apparatus for wireless communication, in accordance with the present disclosure.

### DETAILED DESCRIPTION

Packet data convergence protocol (PDCP) is a layer 2 (L2) protocol that sits on top of (e.g., is above) a radio link control (RLC) protocol in a 5G New Radio (NR) protocol stack. A PDCP layer of a transmitting device may assign sequence numbers to packets of data to be transmitted to a receiving device. In many cases, a PDCP of the receiving device may deliver the packets received from the transmitting device to an upper level of the receiving device using ordered delivery. “Ordered delivery” refers to the PDCP layer delivering packets in the order of the sequence numbers assigned to the packets. In such ordered delivery, if one or more packet(s) is received at the PDCP layer out of order (e.g., the packet(s) is received prior to a missing packet with a lower sequence number), the PDCP layer may start a reordering timer (e.g., an L2 reordering timer) and buffer the packet(s) until the missing packet(s) is received or the reordering timer expires. If the missing packet is received prior to the expiration of the reordering timer, the PDCP layer may deliver the packets in the order of the sequence numbers (e.g., the missing packet, followed by the buffered packet). If the reordering time expires (without receiving the missing packet), the PDCP layer may then deliver the buffered packet(s), but the PDCP layer may not deliver the missing packet if the missing packet is received after the reordering timer has expired (e.g., delivery with gap/hole in the packet sequence occurs).

In some examples, out of order delivery (OOD) may be enabled for PDCP traffic at a receiving device, such as a user equipment (UE). “OOD” or “immediate delivery” refers to the PDCP layer delivering packets in the order that the packets are received at the PDCP layer, which may be out of order with respect to the sequence numbers assigned to the packets. OOD is a feature for improving latency of traffic in a wireless channel by enabling delivery of packets received out of order without waiting for expiration of a reordering time (e.g., an L2 reordering timer). In OOD, the PDCP layer may act as a pass through, and the PDCP layer may immediately deliver a packet received at the PDCP layer to an upper layer even if a missing packet with a lower sequence number has not yet been received at the PDCP layer.

Some applications based on user datagram protocol (UDP) may be able to handle out of order traffic patterns associated with OOD by implementing a reordering mechanism at the application level and/or dropping packets based on latency requirements of the applications. In some examples, UDP-based applications, such as extended reality (XR) applications, virtual reality (VR) applications, gaming applications, video conferencing applications, and/or voice applications, among other examples, may be associated with strict latency requirements, and OOD may reduce latency for traffic associated with such UDP-based applications. However, for applications based on transmission control protocol (TCP), OOD may cause packets to be received at a TCP stack out of order, resulting in increased packet retransmissions and duplicate acknowledgements. Thus, OOD may reduce throughput for such TCP-based applications, particularly in a lossy environment in which packets may be received at the PDCP layer out of order. In some versions, the QUIC transport layer protocol may be tolerant to OOD, unlike the TCP protocol.

In some examples, OOD for a PDCP layer of a UE may be enabled only at a radio bearer (also referred to as “bearer”) level. That is, a PDCP layer may be enabled to perform OOD for all traffic associated with a certain bearer. For example, an application executing on the UE (or on another device which received traffic delivered by the PDCP layer of the UE) may enable OOD for a bearer on which the traffic for that application is to be delivered. However, in some examples, a bearer (e.g., a default internet bearer) may be associated with concurrent traffic for multiple different applications. Thus, when OOD is enabled for a bearer by one application, the OOD may have an unintended effect on one or more other applications which are unaware of the OOD enablement. For example, traffic for a delay sensitive UDP-based application and traffic for a TCP-based application may be associated with the same bearer. In such an example, when the delay sensitive UDP-based application enables OOD for the bearer (e.g., to improve traffic latency for the UDP-based application), the OOD may result in decreased throughput for the TCP-based application due to duplicate acknowledgements and increased retransmissions.

Various aspects relate generally to wireless communication and more particularly to delivery of packets by a PDCP layer of a receiver (e.g., a UE or a network node). Some aspects, more specifically relate to a hybrid PDCP delivery in which OOD (e.g., immediate delivery) is used for some packets associated with a bearer and ordered delivery is used for other packets associated with the same bearer. In some aspects, a receiver may receive, at a PDCP layer, PDCP traffic that includes a plurality of packets associated with a bearer. The receiver (e.g., the PDCP layer of the receiver) may select, for each packet of the plurality of packets, between immediate delivery or ordered delivery. For each packet, the receiver may select between immediate delivery or ordered delivery based at least in part on one or more packet parameters associated with the packet. The receiver (e.g., the PDCP layer of the receiver) may deliver the plurality of packets (e.g., to an upper layer) in accordance with the selection between immediate delivery or ordered delivery for each packet. For example, the PDCP layer of the receiver may perform immediate delivery (e.g., OOD) of one or more packets for which immediate delivery is selected, and the PDCP layer of the receiver may perform ordered delivery of one or more packets for which ordered delivery is selected. In some examples, the one or more packet parameters used by the PDCP layer of the receiver to select between immediate delivery or ordered delivery for a packet may include a packet size and/or a packet arrival time or may include packet header information.

Particular aspects of the subject matter described in this disclosure can be implemented to realize one or more of the following potential advantages. By selecting between immediate delivery or ordered delivery for each packet of a plurality of packets associated with the same bearer, the PDCP layer of the receiver may apply immediate delivery (e.g., OOD) for packets of delay sensitive data (e.g., packets associated with UDP-based applications, such as XR, VR, gaming, video conferencing, and/or voice packets) and may apply ordered delivery for packets associated with other data (e.g., packets associated with TCP-based applications). In this way, the PDCP layer of the receiver may reduce latency for UDP-based application traffic without decreasing throughput for TCP-based application traffic associated with the same bearer as the UDP-based application traffic. In some examples, by selecting between immediate delivery or ordered deliver for each packet based at least in part on one or more packet parameters, such as packet size, packet arrival time, and/or header information, the PDCP layer may distinguish between packets for which immediate delivery (e.g., OOD) is preferred (e.g., UDP-based application traffic) and packets for which ordered delivery is preferred (e.g., TCP-based application traffic) with or without knowledge, at the PDCP layer, of the specific applications associated with the different packets. In some examples various applications may convey their preference for ordered/immediate delivery for various flows to the PDCP layer.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or NR radio access technology (RAT), aspects of the present disclosure can be applied to other RATs, such as a 3G RAT, a 4G RAT, and/or a RAT subsequent to 5G (e.g., 6G).

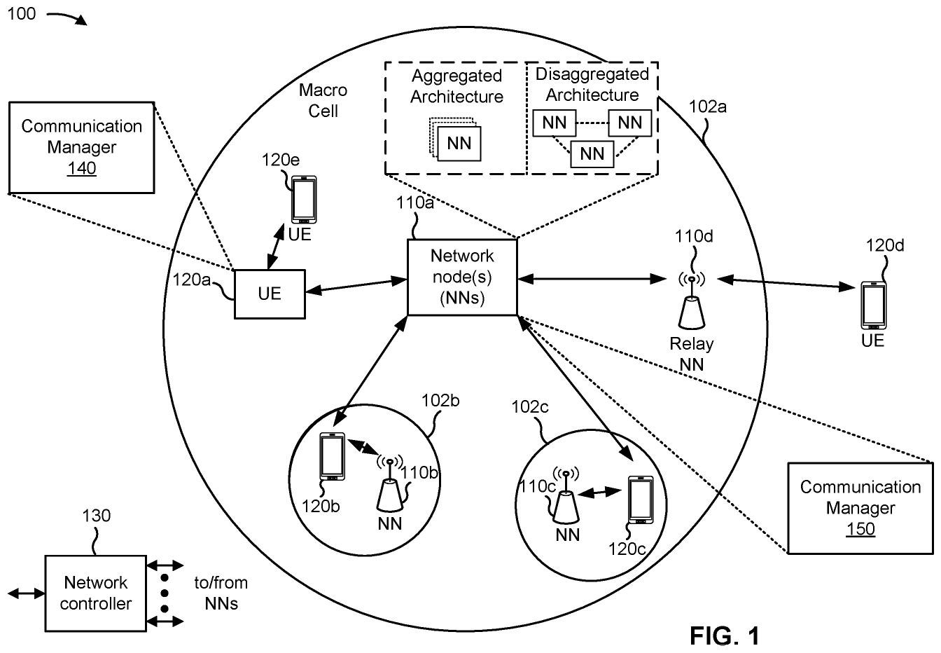

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a UE 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, an unmanned aerial vehicle, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FRI is greater than 6 GHZ, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHZ), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHZ, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may receive, at a PDCP layer, PDCP traffic including a plurality of packets associated with a bearer; select, for each packet of the plurality of packets, between immediate delivery or ordered delivery based at least in part on one or more packet parameters associated with the packet; and deliver the plurality of packets in accordance with the selection between immediate or ordered delivery for each packet of the plurality of packets. Additionally, or alternatively, the communication manager 140 may perform one or more other operations described herein.

In some aspects, the network node 110 may include a communication manager 150. As described in more detail elsewhere herein, the communication manager 150 may receive, at a PDCP layer, PDCP traffic including a plurality of packets associated with a bearer; select, for each packet of the plurality of packets, between immediate delivery or ordered delivery based at least in part on one or more packet parameters associated with the packet; and deliver the plurality of packets in accordance with the selection between immediate or ordered delivery for each packet of the plurality of packets. Additionally, or alternatively, the communication manager 150 may perform one or more other operations described herein.

As indicated above, FIG. 1 is provided as an example. Other examples may differ from what is described with regard to FIG. 1.

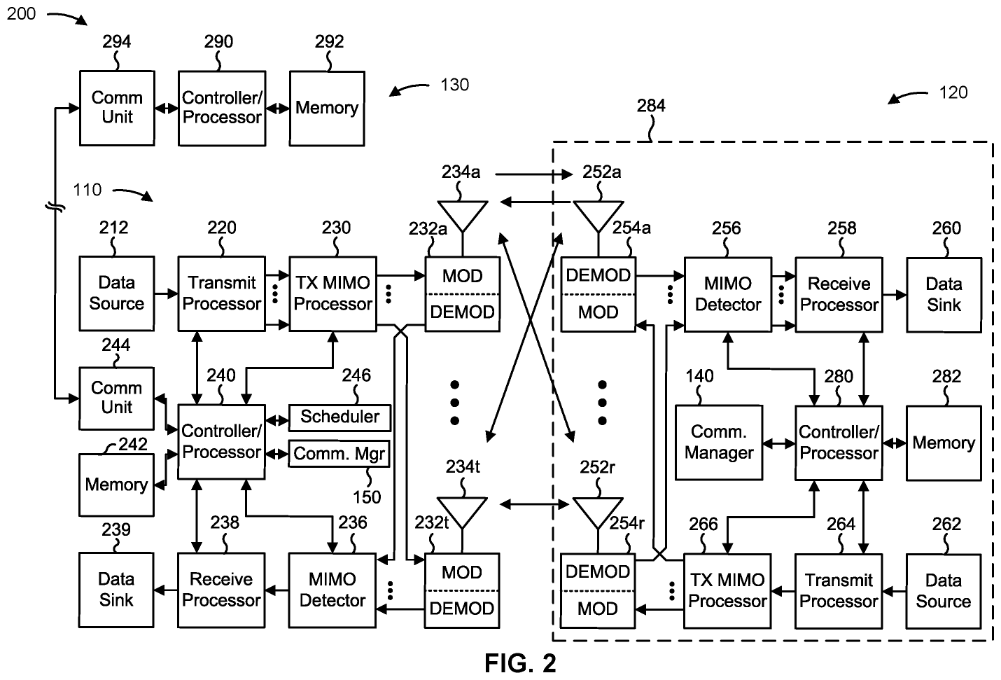

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

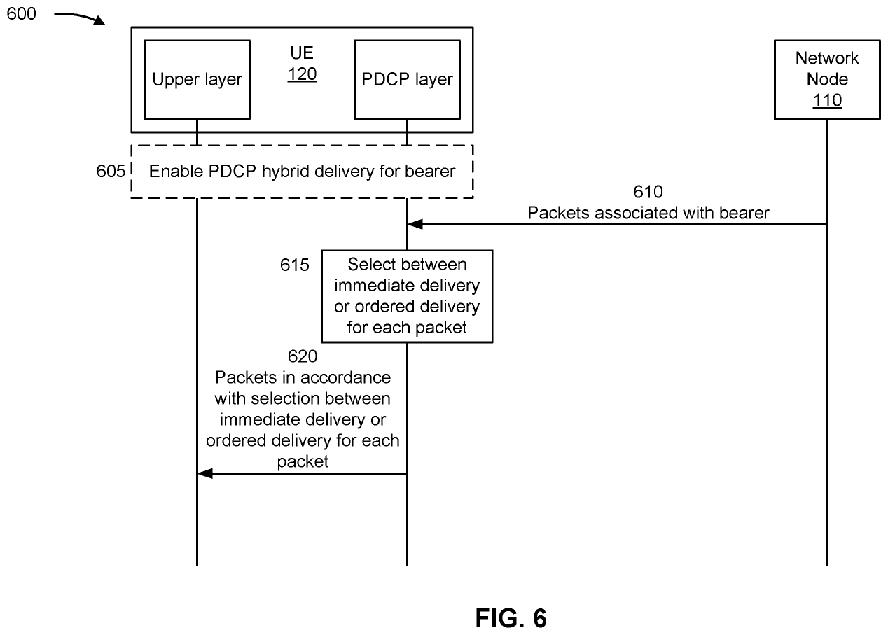

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 6-9).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 6-9).

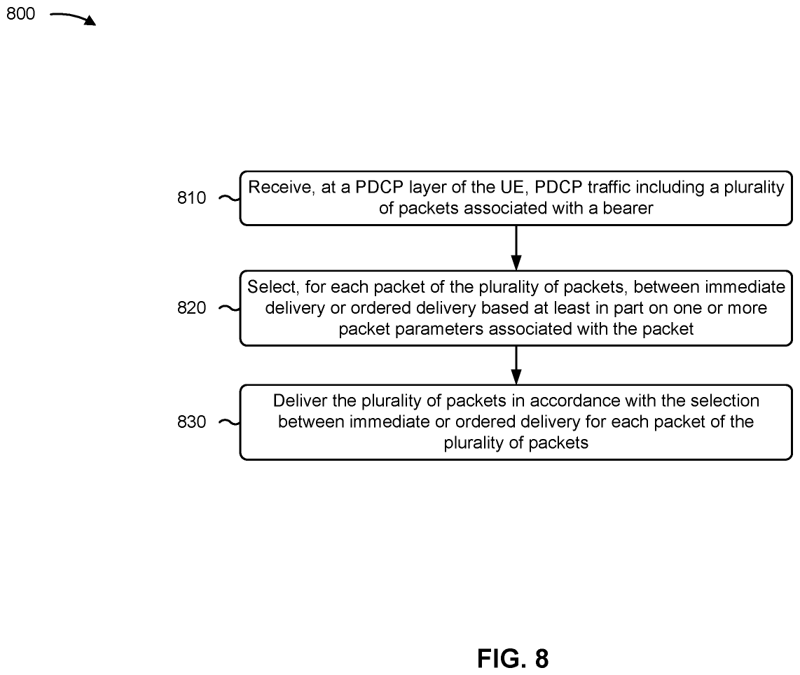

The controller/processor 240 of the network node 110, the controller/processor 280 of the UE 120, and/or any other component(s) of FIG. 2 may perform one or more techniques associated with PDCP hybrid delivery, as described in more detail elsewhere herein. For example, the controller/processor 240 of the network node 110, the controller/processor 280 of the UE 120, and/or any other component(s) of FIG. 2 may perform or direct operations of, for example, process 800 of FIG. 8, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 800 of FIG. 8, and/or other processes as described herein. In some examples, executing instructions may include running the instructions, converting the instructions, compiling the instructions, and/or interpreting the instructions, among other examples.

In some aspects, a receiver (e.g., a UE 120 or a network node 110) includes means for receiving, at a PDCP layer of the receiver, PDCP traffic including a plurality of packets associated with a bearer; means for selecting, for each packet of the plurality of packets, between immediate delivery or ordered delivery based at least in part on one or more packet parameters associated with the packet; and/or means for delivering the plurality of packets in accordance with the selection between immediate or ordered delivery for each packet of the plurality of packets. In some aspects, the means for the receiver to perform operations described herein may include, for example, one or more of communication manager 140, antenna 252, modem 254, MIMO detector 256, receive processor 258, transmit processor 264, TX MIMO processor 266, controller/processor 280, or memory 282. In some aspects, the means for the receiver to perform operations described herein may include, for example, one or more of communication manager 150, antenna 234, modem 232, MIMO detector 236, receive processor 238, transmit processor 220, TX MIMO processor 230, controller/processor 240, or memory 242.

In some aspects, an individual processor may perform all of the functions described as being performed by the one or more processors. In some aspects, one or more processors may collectively perform a set of functions. For example, a first set of (one or more) processors of the one or more processors may perform a first function described as being performed by the one or more processors, and a second set of (one or more) processors of the one or more processors may perform a second function described as being performed by the one or more processors. The first set of processors and the second set of processors may be the same set of processors or may be different sets of processors. Reference to “one or more processors” should be understood to refer to any one or more of the processors described in connection with FIG. 2. Reference to “one or more memories” should be understood to refer to any one or more memories of a corresponding device, such as the memory described in connection with FIG. 2. For example, functions described as being performed by one or more memories can be performed by the same subset of the one or more memories or different subsets of the one or more memories.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

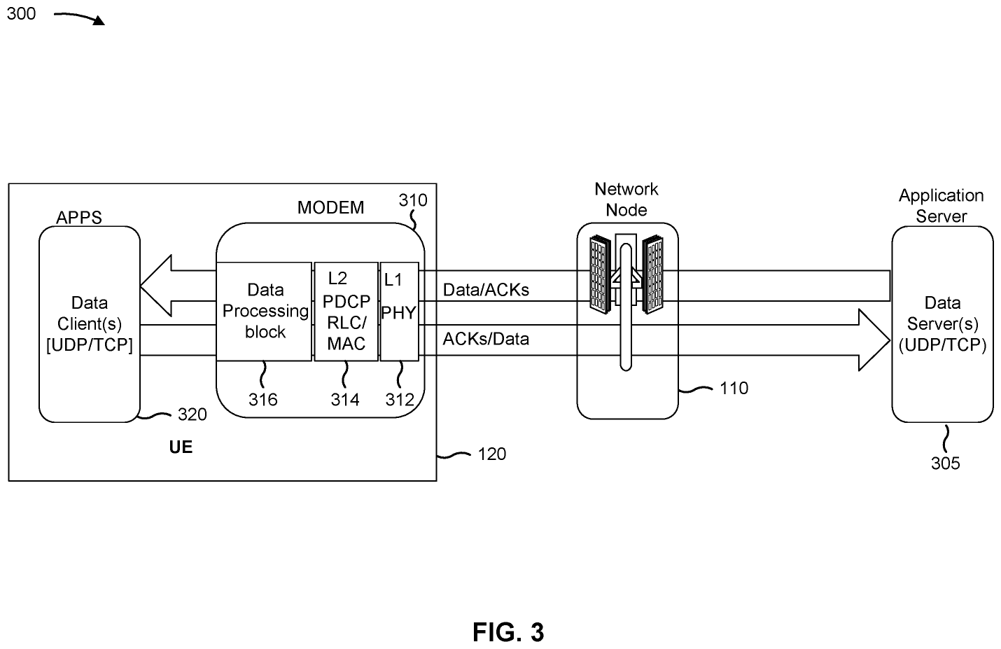

FIG. 3 is a diagram illustrating an example 300 of an end-to-end data path for data associated with a UE, in accordance with the present disclosure. As shown in FIG. 3, example 300 includes a UE 120, a network node 110, and an application server 305. The UE 120 may communicate with the application server 305 via the network node 110.

As shown in FIG. 3, the application server 305 may transmit data and acknowledgements (ACKs) to the UE 120 via the network node 110, and the UE 120 may transmit ACKs and data to the application server 305 via the network node 110. The ACKs transmitted by the UE 120 may be transmitted in response to receiving the data transmitted by the application server 305, and the ACKs transmitted by the applications server may be transmitted in response to receiving the data transmitted by the UE 120. A modem 310 of the UE 120 may receive the data and ACKs transmitted from the application server via the network node 110. The modem may deliver the data received (via the network node 110) from the application server 305 to one or more applications (shown as “APPS”) 320 executing on the UE 120 or on peripheral device attached or in communications with to the UE. For example, the one or more applications 320 may include one or more data clients (e.g., UDP and/or TCP data clients) associated with the one or more data servers of the application server 305. The modem 310 may obtain data from the one or more applications 320, and the modem 310 may transmit the data obtained from the one or more applications 320 to the application server 305 via the network node 110. The modem may also transmit the ACKs to the application server 305 via the network node in response to receiving the data transmitted from the application server.

The modem 310 of the UE 120 may include layer 1 (L1) 312 and L2 314 of a protocol stack of the UE 120, as well as a data processing block 316. L1 312 may include a physical (PHY) layer of the UE 120. The PHY layer may perform various operations relating to transmission and reception of data signals. For example, the PHY layer may receive data and ACKs transmitted from the application server 305 via the network node 110, and the PHY layer may transmit ACKs and data to the application server 305 via the network node 110. L2 314 may include a medium access control (MAC) layer, an RLC layer, and a PDCP layer. The PHY layer may receive transport blocks (TBs) using hybrid automatic repeat request (hybrid ARQ or HARQ) including data (e.g., packets) and may provide the TBs one or more transport channels to the MAC layer. The MAC layer may map the transport channels to logical channels and may provide the data to the RLC layer via the logical channels. The RLC layer may map the logical channels to RLC channels and may provide the data to the PDCP layer via the RLC channels. The PDCP layer may map the RLC channels to radio bearers and may deliver the data to one or more upper layers via the radio bearers. For example, the one or more upper layers may include a radio resource control (RRC) layer (e.g., layer 3 (L3)) of the UE 120 and/or an application layer of the UE 120 or a peripheral device. The data processing block 316 performs processing of the data in connection with delivering the data from the PDCP layer to the one or more upper layers. For example, the data processing block 316 may process the data to perform PDCP header removal, deciphering, integrity verification, and/or header decompression, among other examples.

As indicated above, FIG. 3 is provided as an example. Other examples may differ from what is described with respect to FIG. 3.

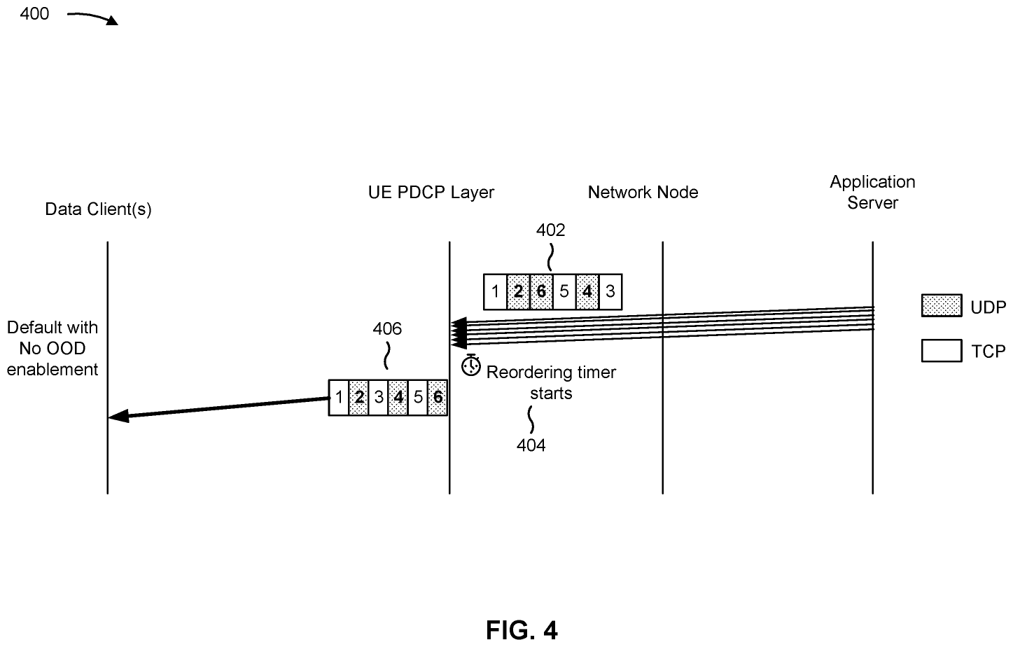

FIG. 4 is a diagram illustrating an example 400 of PDCP ordered delivery, in accordance with the present disclosure.

As shown in FIG. 4, and by reference number 402, an application server may transmit, via a network node, a plurality of packets (e.g., packets 1-6) to the UE, and the plurality of packets may be received at a PDCP layer of the UE. The plurality of packets may be associated with respective sequence numbers (e.g., 1-6 in FIG. 4). For example, each packet, of the plurality of a packets, may be assigned a sequence number by a PDCP layer of the network node. The sequence numbers associated with the packets may indicate an intended order for the plurality of packets. As shown in FIG. 4, the packets may be received at the PDCP layer of the UE out of order. For example, the packets may be received at the PDCP layer of the UE in the order of packet 1, packet 2, packet 6, packet 5, packet 4, and packet 3, instead of being received in sequential order from packet 1 through packet 6. As shown in FIG. 4, the packets may include UDP packets (e.g., packets 2, 4, and 6) and TCP packets (e.g., packets 1, 3, and 5). For example, the packets may include UDP packets and TCP packets associated with a same bearer.

In example 400, the PDCP of the UE may use ordered delivery to deliver the packets. “Ordered delivery” refers to the PDCP layer delivering packets in the order of the sequence numbers assigned to the packets. The ordered delivery may be based at least in part on no OOD being enabled by a data client for the bearer associated with the packets. In ordered delivery, when the PDCP layer receives a packet, the PDCP layer determines whether the sequence number associated with the packet is in sequence (e.g., whether the packet has been received in order). The PDCP layer may determine that the sequence number associated with the packet is in sequence if all of the packets associated with all previous (e.g., lower) sequence numbers have already been delivered by the PDCP layer. For example, the PDCP layer may determine that the sequence numbers for packet 1 and packet 2 are in sequence (e.g., packet 1 and packet 2 are received in order) in example 400. In this case, the PDCP layer delivers packet 2 (e.g., to an upper layer) because packet 1 has already been received (and delivered).

The PDCP layer may determine that the sequence number associated with the packet is out of sequence if any packet associated with a previous (e.g., lower) sequence number has not yet been delivered by the PDCP layer. As shown by reference number 404, if the PDCP layer determines that a sequence number associated with a packet received at the PDCP layer is out of sequence (e.g., the packet is received at the PDCP layer out of order), the PDCP layer may start a reordering timer (e.g., an L2 reordering timer). For example, the PDCP layer may start the reordering timer in connection with receiving packet 6 prior to packets 3-5 in example 400. For each packet received out of order (e.g., packet 6, packet 5, and packet 4 in example 400), the PDCP layer may buffer the packet until all of the packets associated with the previous sequence numbers are delivered by the PDCP layer or until the reordering timer expires. If the packets associated with the previous sequence numbers are received and delivered prior to the expiration of the reordering timer, the PDCP layer may deliver the packets in the order of the sequence numbers. If the reordering time expires (without delivering one or more missing packets associated with previous sequence numbers), the PDCP layer may then deliver the buffered packet, but the PDCP layer may not deliver the one or more missing packets if the one or more missing packets are received after the reordering timer has expired.

As shown by reference number 406, the PDCP layer of the UE may deliver the packets in the order of the sequence numbers of the packets. In example 400, the PDCP layer of the UE may buffer packets 6, 5, and 4 (after delivering packets 1 and 2) until packet 3 is received, and then the PDCP layer of the UE may deliver packets 3, 4, 5, and 6 in order of the sequence numbers. The PDCP layer of the UE may deliver the packets to an upper layer of the UE. For example, the PDCP may deliver the packets to one or more data clients (e.g., one or more applications) executing on an upper layer (e.g., an application layer) of the UE. Additionally, or alternatively, the PDCP layer of the UE may deliver (e.g., via an upper layer of UE) the packets to one or more data clients associated with another device, for example in a case in which the UE is serving as an AP or tethered host for the other device.

As indicated above, FIG. 4 is provided as an example. Other examples may differ from what is described with respect to FIG. 4.

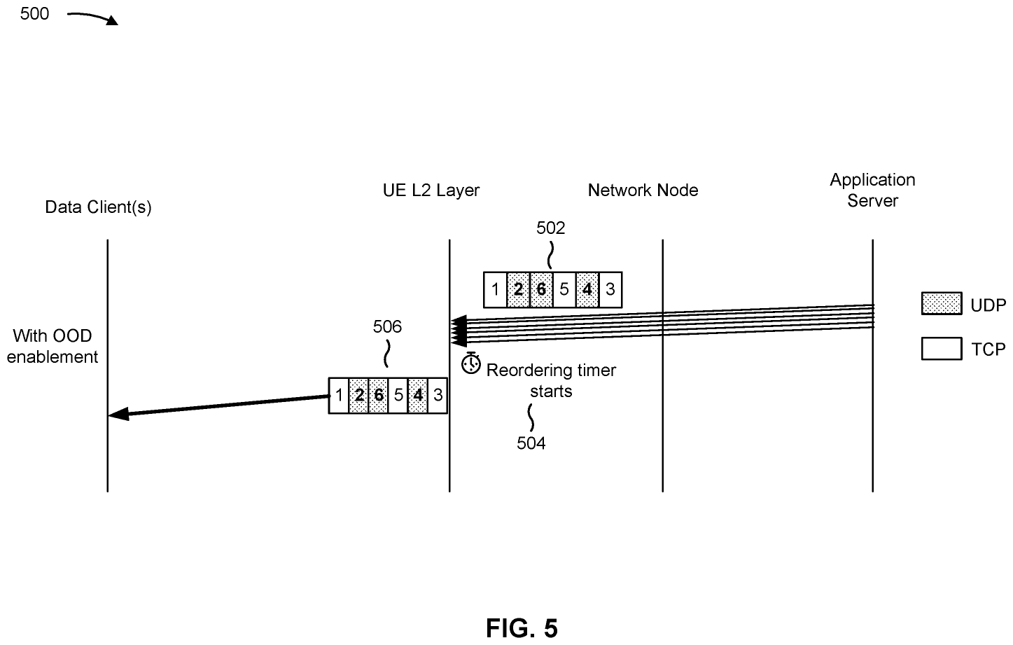

FIG. 5 is a diagram illustrating an example 500 of PDCP OOD, in accordance with the present disclosure.

As shown in FIG. 5, and by reference number 502, an application server may transmit, via a network node, a plurality of packets (e.g., packets 1-6) to the UE, and the plurality of packets may be received at a PDCP layer of the UE. The plurality of packets may be associated with respective sequence numbers (e.g., 1-6 in FIG. 5). For example, each packet, of the plurality of packets, may be assigned a sequence number by a PDCP layer of the network node. The sequence numbers associated with the packets may indicate an intended order for the plurality of packets. As shown in FIG. 5, the packets may be received at the PDCP layer of the UE out of order. For example, the packets may be received at the PDCP layer of the UE in the order of packet 1, packet 2,packet 6, packet 5, packet 4, and packet 3, instead of being received in sequential order from packet 1 through packet 6. As shown in FIG. 5, the packets may include UDP packets (e.g., packets 2, 4, and 6) and TCP packets (e.g., packets 1, 3, and 5). For example, the packets may include UDP packets and TCP packets associated with a same bearer.

In example 500, the PDCP of the UE may use OOD to deliver the packets. “OOD” or “immediate delivery” refers to the PDCP layer delivering packets in the order that the packets are received at the PDCP layer, which may be out of order with respect to the sequence numbers assigned to the packets. In some examples, the OOD may be based at least in part on a data client (e.g., an application) enabling OOD for the bearer associated with the packets. In OOD, when a packet is received, the PDCP layer may update PDCP receive (Rx) status to indicate that the packet is received and immediately deliver the packet (unless the packet can no longer be delivered due to expiration of a reordering timer). As shown by reference number 504, if the PDCP layer determines that a sequence number associated with a packet received at the PDCP layer is out of sequence (e.g., the packet is received at the PDCP layer out of order), the PDCP layer may start a reordering timer (e.g., an L2 reordering timer). In this case, the PDCP layer may immediately deliver the packet that is received out of order (e.g., as opposed to buffering the packet in the case of ordered delivery) and start the reordering timer. For example, the PDCP layer may start the reordering timer and immediately deliver packet 6 when packet 6 is received in example 500. If the reordering timer expires prior to receiving/delivering one or more missing packets associated with previous (e.g., lower) sequence numbers, the PDCP layer may not deliver the one or more missing (e.g., lower sequence) packets if the one or more missing packets are received after the reordering timer has expired. However, in OOD, the PDCP layer does not wait for the reordering timer to expire to deliver the packet that is received out of order.

As shown by reference number 506, the PDCP layer of the UE may deliver the packets in the same order in which the packets were received at the PDCP layer (e.g., packet 1, packet 2, packet 6, packet 5, packet 4, and packet 3 in example 500), if the packets are all received before expiration of the timer. The PDCP layer may immediately deliver each packet when that packet is received. In example 500, the PDCP layer may receive packets 5, 4, and 3 prior to the expiration of the reordering timer started when packet 6 was received, and thus deliver all of the packets in the order that the packets were received at the PDCP layer. The PDCP layer of the UE may deliver the packets to an upper layer of the UE. For example, the PDCP may deliver the packets to one or more data clients (e.g., one or more applications) executing on an upper layer (e.g., an application layer) of the UE. Additionally, or alternatively, the PDCP layer of the UE may deliver (e.g., via an upper layer of UE) the packets to one or more data clients associated with another device, for example in a case in which the UE is serving as an AP or tethered host for the other device.

As indicated above, FIG. 5 is provided as an example. Other examples may differ from what is described with respect to FIG. 5.

FIG. 6 is a diagram illustrating an example 600 associated with PDCP hybrid delivery, in accordance with the present disclosure. As shown in FIG. 6, example 600 includes communication between a network node 110 and a UE 120. In some aspects, the network node 110 and the UE 120 may be included in a wireless network, such as wireless network 100. The network node 110 and the UE 120 may communicate via a wireless access link, which may include an uplink and a downlink. As shown in FIG. 6, the UE 120 may include a PDCP layer and an upper layer. For example, the upper layer may be an application layer or an RRC layer (e.g., L3), among other examples.

As shown in FIG. 6, and by reference number 605, the UE 120 may enable PDCP hybrid delivery for a bearer. The upper layer and/or the PDCP layer of the UE 120 may enable PDCP hybrid delivery to be used by the PDCP layer for the bearer. In some aspects, an application executing on the UE 120 (e.g., on the application layer) may indicate, to the PDCP layer, that PDCP OOD is enabled (or a request for PDCP OOD to be enabled) for a bearer on which data associated with that application is to be delivered, and the PDCP layer may enable PDCP hybrid delivery for the bearer in connection with the application indicating that PDCP OOD is enabled (or requesting that PDCP be enabled) for the bearer. In some aspects an upper layer may indicate a plurality of filters describing flows requiring immediate delivery, or a plurality of filters describing flows requiring ordered delivery. In some aspects, the operations described in connection with reference numbers 610, 615, and 620 may be performed by the UE 120 in connection with PDCP hybrid delivery being enabled for a bearer.

As further shown in FIG. 6, and by reference number 610, the network node 110 may transmit, and the PDCP layer of the UE 120 may receive, PDCP traffic including a plurality of packets associated with the bearer (e.g., the bearer for which PDCP hybrid delivery is enabled). For example, the PDCP layer of the UE 120 may receive the plurality of packets via a PHY layer, a MAC layer, and/or an RLC layer of the UE 120, as described in connection with FIG. 3. In some aspects, the packets may be associated with respective sequence numbers. For example, a PDCP layer of the network node 110 may assign a sequence number to each packet of the plurality of packets. The sequence numbers associated with the packets may indicate an intended order or sequence of the packets. In some aspects, the plurality of packets may be received out of order. For example, the plurality of packets may be received, at the PDCP layer of the UE 120, in an order other than a sequential order of the sequence numbers associated with the plurality of packets.

In some aspects, the plurality of packets may include different types of packets that are associated with the same bearer. For example, the plurality of packets may include one or more UDP packets (e.g., packets associated with one or more UDP-based applications) and one or more TCP packets (e.g., packets associated with one or more TCP-based applications), among other examples. In some aspects, the plurality of packets may include one or more XR packets, VR packets, gaming packets, video packets, and/or voice packets, among other examples. In some aspects, the plurality of packets may include packets associated with one or more data clients. For example, the one or more data clients may include one or more applications executing on the UE 120 (e.g., on the application layer) and/or one or more applications executing on another device in communication with the UE 120 (e.g., in a case in which the UE 120 is serving as an AP or tethered host for the other device). In some aspects, the plurality of packets may be transmitted from one or more application servers to the UE 120, via the network node 110. As shown in FIG. 6, in example 600, the plurality of packets are transmitted to the UE 120 by the network node 110 via one or more downlink communications. In some other examples, the plurality of packets may be transmitted to the UE 120 by another UE via one or more sidelink communications.

As further shown in FIG. 6, and by reference number 615, the PDCP layer of the UE 120 may select, for each packet of the plurality of packets, between immediate delivery (e.g., OOD) or ordered delivery. For each packet, of the plurality of packets, received at the PDCP layer of the UE 120, the PDCP layer of the UE 120 may select between immediate delivery or ordered delivery based at least in part on one or more packet parameters associated with that packet. For example, when a packet of the plurality of packets (e.g., a packet associated with the bearer on which PDCP hybrid delivery is enabled) is received at the PDCP layer of the UE 120, the PDCP layer of the UE 120 may select, based at least in part on one or more packet parameters associated with the packet, whether to deliver the packet using immediate delivery (e.g., OOD) or ordered delivery. The PDCP layer of the UE 120 may perform such a selection between immediate delivery or ordered delivery on a per packet basis each time a packet, of the plurality of packets in received at the PDCP of the UE 120.

In some aspects, the PDCP of the UE 120 may use the one or more packet parameters to select immediate delivery (e.g., OOD) for a first type (or types) of packets (e.g., UDP packets, XR packets, VR packets, gaming packets, video packets, voice packets, internal control message protocol (ICMP) (ping) packets, and/or packets matching some filter associated with flows requiring immediate delivery, among other examples) and to select ordered delivery for another type (or types) of packets (e.g., TCP packets, bulk data packets, QUIC packets, and/or packets matching some filter associated with flows requiring ordered delivery, among other examples). For example, the one or more packet parameters may include one or more parameters that can be used by the PDCP of the UE 120 to distinguish between the first type (or types) of packets and the second type (or types) or packets.

In some aspects, the one or more packet parameters used to select between immediate delivery or ordered delivery for a packet may include a packet size associated with the packet. For example, different types of packets may be associated with different packet sizes. In some aspects, the PDCP layer of the UE 120 may select between immediate delivery and ordered deliver for a packet based at least in part on a comparison a packet size associated with the packet and a reference packet size. The reference packet size may be a packet size associated with a certain type of packet. For example, the PDCP layer of the UE 120 may select immediate delivery for the packet if the difference between the packet size associated with the packet and the reference packet size satisfies (e.g., is less than or equal to) a threshold. In such examples, the PDCP layer of the UE 120 may select ordered delivery if the difference between the packet size associated with the packet and the reference packet size does not satisfy (e.g., is greater than) the threshold. For example, XR and/or VR (XR/VR) traffic may be transmitted using UDP transport protocol with packet sizes near 700 bytes. In such an example, the PDCP layer of the UE 120 can compare a packet size of a packet with a reference packet size of 700 bytes. If the difference between the packet size and the reference packet size of 700 bytes satisfies (e.g., is less than or equal to) a threshold, the PDCP layer of the UE 120 may select immediate delivery for the packet. If the difference between the packet size and the reference packet size of 700 bytes does not satisfy (e.g., is greater than) the threshold, the PDCP layer of the UE 120 may select ordered delivery for the packet. In this way, the PDCP layer of the UE 120 may use packet size to select immediate delivery for XR/VR packets (e.g., without the PDCP layer of the UE 120 having specific knowledge that the packets are XR/VR packets). In some examples, the determination uses a range of packet sizes. For example, if the packet size is in the range [200, 350] bytes, the PDCP layer of the UE 120 may select immediate delivery to be used for the packet.

In some aspects, the one or more packet parameters used to select between immediate delivery or ordered delivery for a packet may include a type of packet indicated in a packet header associated with the packet. In one example the PDCP header may include an indication to select ordered or immediate delivery. In other examples, the transport protocol header may include an indication to select ordered or immediate delivery. For example, the indication of the type of packet may be included in a packet header associated with a higher layer than a service data adaptation protocol (SDAP) layer (e.g., an internet protocol (IP) layer or above). In such examples, the PDCP layer of the UE 120 may decipher all or a portion of an IP header (e.g., an IP transport header), TCP header, a UDP header, or a real-time transport protocol (RTP) header of a packet to determine a type of the packet. For example, the type of the packet may correspond to the transport protocol (e.g., TCP or UDP) associated with the packet. The type of the packet may be indicated explicitly or implicitly by the header (e.g., the IP header, TCP header, UDP header, or RTP header) of the packet. In some examples, the PDCP layer of the UE 120 may determine, based at least in part on the header associated with the packet, whether the packet is a UDP packet or a TCP packet, or based on matching some fields such as IP address, port, QoS, etc. In such examples, the PDCP layer of the UE 120 may select immediate delivery for the packet if the packet header indicates that the packet is a UDP packet, and the PDCP layer of the UE 120 may select ordered delivery for the packet if the packet header indicates that the packet is a TCP packet.

In some aspects, the one or more packet parameters used to select between immediate delivery or ordered delivery for a packet may include a parameter indicated in an SDAP header associated with the packet. The SDAP layer is a layer included in L2 that is above the PDCP layer for a user plane data in the 5G NR radio protocol stack. In some aspects, one or more bits of an SDAP header associated with a packet may be used to indicate a type of packet (e.g., TCP or UDP). In such examples, the PDCP layer of the UE 120 may select between immediate delivery (e.g., if the packet is a UDP packet) or ordered delivery (e.g., if the packet is a TCP packet) based at least in part on the type of packet indicated in the SDAP header associated with the packet. In some examples, the SDAP header associated with a packet may include an indication (e.g., a one bit indication) of whether or not immediate delivery is to be used for the packet. In such examples, the PDCP layer of the UE 120 may select immediate delivery for the packet in connection with the SDAP header indicating (e.g., using a first bit value) that immediate delivery is to be used, or the PDCP layer of the UE 120 may select ordered delivery for the packet in connection with the SDAP header indicating (e.g., using a second bit value) that immediate delivery is not to be used.

In some aspects, the one or more packet parameters used to select between immediate delivery or ordered delivery for a packet may include a parameter indicated in a PDCP header associated with the packet. In some aspects, one or more bits of an PDCP header associated with a packet may be used to indicate a type of packet (e.g., TCP or UDP). In such examples, the PDCP layer of the UE 120 may select between immediate delivery (e.g., if the packet is a UDP packet) or ordered delivery (e.g., if the packet is a TCP packet) based at least in part on the type of packet indicated in the SDAP header associated with the packet. In some examples, the PDCP header associated with a packet may include an indication (e.g., a one bit indication) of whether or not immediate delivery is to be used for the packet. In such examples, the PDCP layer of the UE 120 may select immediate delivery for the packet in connection with the PDCP header indicating (e.g., using a first bit value) that immediate delivery is to be used, or the PDCP layer of the UE 120 may select ordered delivery for the packet in connection with the PDCP header indicating (e.g., using a second bit value) that immediate delivery is not to be used.

In some aspects, the PDCP layer of the UE 120 may use a machine learning (ML) model to select between immediate delivery or ordered delivery for a packet based at least in part on one or more packet parameters associated with the packet. For example, the one or more packet parameters may include a packet size associated with the packet, a packet arrival time, and/or various portions of the packet header. Different types of traffic and/or traffic associated with different types of applications (e.g., XR/VR traffic and/or gaming traffic, among other examples) may utilize different packet sizes and different traffic patterns. In some aspects, the ML model may be trained to distinguish between (e.g., classify) different types of packets based at least in part on packet size and packet arrival time. In some examples, the ML model may input the packet size and the packet arrival time of a packet and output the selection of immediate delivery or ordered delivery for the packet based at least in part on the packet size and the packet arrival time. In some other examples, the ML model may input the packet size and the packet arrival time of a packet and output a type of the packet based at least in part on the packet size and the packet arrival time. In this case, the PDCP layer of the UE 120 may select between immediate delivery or ordered delivery for the packet based at least in part on the type of packet determined using the ML model.

As further shown in FIG. 6, and by reference number 620, the PDCP layer of the UE 120 may deliver, to the upper layer of the UE 120, the plurality of packets in accordance with the selection between immediate delivery or ordered delivery for each packet of the plurality of packets. The PDCP layer of the UE 120 may deliver the plurality of packets on the bearer associated with the plurality of packets. For each packet of the plurality of packets, the PDCP layer of the UE 120 may deliver the packet using immediate delivery in connection with the PDCP layer selecting immediate delivery for the packet, or the PDCP layer of the UE 120 may deliver the packet using ordered delivery in connection with the PDCP layer selecting ordered delivery for the packet.

In some aspects, the PDCP layer may select immediate delivery for a first set of one or more packets of the plurality of packets associated with the bearer, and the PDCP layer may select ordered delivery for a second set of one or more packets of the plurality of packets associated with the bearer. In this case, the PDCP layer may deliver the first set of one or more packets using immediate delivery (e.g., OOD), and the PDCP layer may deliver the second set of one or more packets using ordered delivery. As discussed above in connection with reference number 610, the plurality of packets may be received out of order at the PDCP layer of the UE 120. In some aspects, the delivery of the first set of one or more packets may include the PDCP layer delivering the first set of one or more packets out of order with respect to the sequence numbers associated with the first set of one or more packets, and the delivery of the second set of one or more packets may include the PDCP layer delivering the second set of one or more packets in order with respect to the sequence numbers associated with the second set of one or more packets. In some aspects, XR packets, VR packets, gaming packets, video packets, and/or voice packets may be included in the first set of one or more packets, and bulk data packets may be included in the second set of one or more packets. In some aspects, UDP packets may be included in the first set of one or more packets and TCP packets may be included in the second set of one or more packets.

In the case in which the PDCP layer of the UE 120 selects immediate delivery for a packet, the PDCP layer may deliver the packet using immediate delivery. In this case, in connection with the PDCP layer of the UE 120 receiving the packet and selecting immediate delivery for the packet, the PDCP layer may update a PDCP Rx status associated with the packet to indicate that the packet is received and immediately deliver the packet to the upper layer (unless the packet can no longer be delivered due to expiration of a reordering timer after the reception of an out of order packet). The PDCP layer may immediately deliver the packet even if the sequence number associated with the packet is out of sequence (e.g., the packet is received at the PDCP layer of the UE 120 out of order). If the PDCP layer determines that a sequence number associated with the packet is out of sequence (e.g., the sequence number creates a gap with respect to the sequence numbers associated with previously delivered packets of the one or more packets), the PDCP layer may immediately deliver the packet to the upper layer and start a reordering timer (e.g., an L2 reordering timer) associated with OOD. If the reordering timer associated with OOD expires prior to receiving/delivering a missing packet associated with a previous (e.g., lower) sequence number, the PDCP layer may refrain from delivering the missing packet if the missing packet is received after the reordering timer associated with OOD has expired.

In the case in which the PDCP layer of the UE 120 selects ordered delivery for a packet, the PDCP layer may deliver the packet using ordered delivery. In this case, the PDCP layer may determine whether the sequence number associated with the packet is in sequence (e.g., whether the packet has been received at the PDCP layer of the UE 120 in order). The PDCP layer may determine that the sequence number associated with the packet is in sequence if all of the packets associated with all previous (e.g., lower) sequence numbers have already been delivered by the PDCP layer. The PDCP layer may determine whether a previous packet (e.g., a packet associated with a previous sequence numbers) has already been delivered based at least in part on the PDCP Rx status associated with the previous packet. If PDCP layer determines that the sequence number associated with the packet is in sequence (e.g., all packets associated with previous sequence numbers have already been delivered), the PDCP layer delivers the packet to the upper layer. If the PDCP layer determines that the sequence number associated with the packet is out of sequence (e.g., at least one missing packet associated with a previous (e.g., lower) sequence number has not yet been delivered by the PDCP layer), the PDCP layer may buffer the packet and start a reordering timer (e.g., an L2 reordering timer) associated with ordered delivery. In some examples, different reordering times may be used the reordering timer associated with ordered delivery and the reordering timer associated with OOD. In some other examples, a same reordering time may be used for the reordering timer associated with ordered delivery and the reordering timer associated with OOD.

In ordered delivery, the PDCP layer may buffer the packet until the at least one missing packet associated with the previous sequence number is delivered by the PDCP layer or until the reordering timer expires. If the at least one missing packet associated with the previous sequence numbers is delivered prior to the expiration of the reordering timer, the PDCP layer may deliver the buffered packet after delivering the at least one missing packet. If the reordering timer expires prior to the at least one missing packet associated with the previous sequence number being delivered, the PDCP layer may then deliver the buffered packet without delivering the at least one missing packet. In this case, the PDCP layer may refrain from delivering the at least one missing packet if the at least one missing packet is received after the reordering timer has expired.

In some aspects, the PDCP layer of the UE may deliver the packets to one or more applications (e.g., data clients) executing on the upper layer (e.g., the application layer) of the UE 120. In some aspects, the PDCP layer of the UE 120 may deliver the packets to the upper layer, and the upper layer may deliver the packets to one or more applications (e.g., data clients) executing on the UE 120. Additionally, or alternatively, the PDCP layer of the UE 120 and/or the upper layer of the UE 120 may deliver the packets to another device (e.g., to one or more data clients associated with the other device), for example in a case in which the UE 120 is serving as an AP or tethered host for the other device.

In some aspects, the operations of the UE 120 described above in connection with FIG. 6 may be performed by a receiver (e.g., receiver device). A receiver may be to a wireless communications device (or an apparatus at a wireless communication device) that receives packets from another device. In some examples, the receiver may be a UE (e.g., UE 120), as shown in FIG. 6. In some other examples, the receiver may be a network node (e.g., network node 110). In such examples, the network node (e.g., the PDCP layer of the network node) may perform the operations for the UE 120 in connection with FIG. 6.

As indicated above, FIG. 6 is provided as an example. Other examples may differ from what is described with respect to FIG. 6.

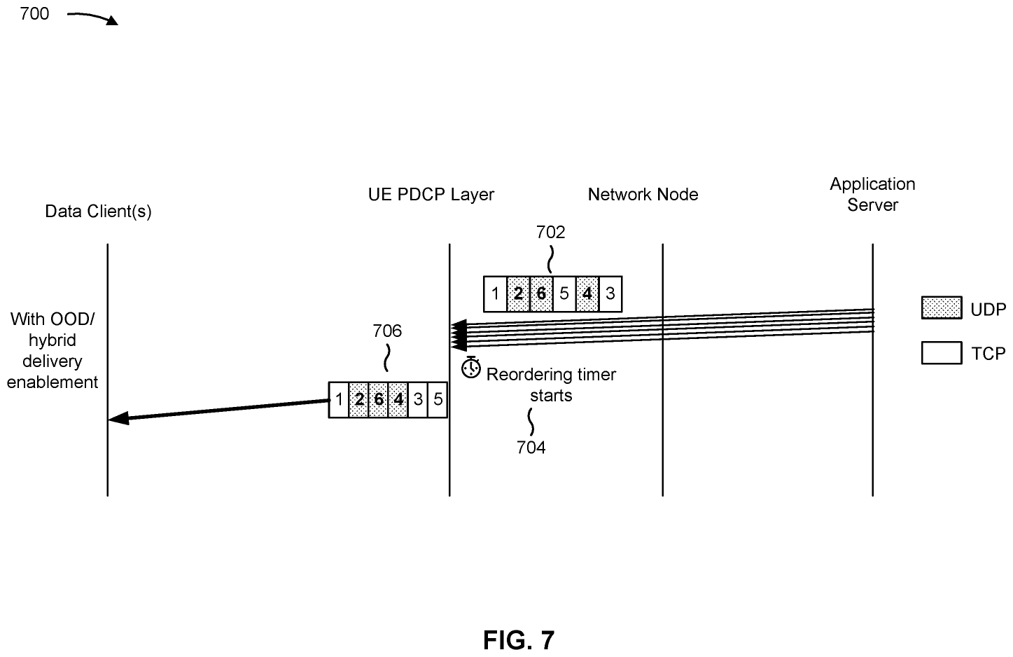

FIG. 7 is a diagram illustrating an example 700 associated with PDCP hybrid delivery, in accordance with the present disclosure.

As shown in FIG. 7, and by reference number 702, an application server may transmit, via a network node (e.g., network node 110), a plurality of packets (e.g., packets 1-6) to a UE (e.g., UE 120), and the plurality of packets may be received at a PDCP layer of the UE. The plurality of packets may be associated with the same bearer. In some aspects, PDCP hybrid delivery may be enabled for the bearer. For example, a data client (e.g., an application executing on the UE) may enable the OOD for the bearer, and the PDCP may enable PDCP hybrid delivery for the bearer based at least in part on the data client enabling OOD for the bearer. The plurality of packets may be associated with respective sequence numbers (e.g., 1-6 in FIG. 5). For example, each packet, of the plurality of a packets, may be assigned a sequence number by a PDCP layer of the network node. The sequence numbers associated with the packets may indicate an intended order for the plurality of packets. As shown in FIG. 7, the packets may be received at the PDCP layer of the UE out of order. For example, the packets may be received at the PDCP layer of the UE in the order of packet 1, packet 2, packet 6, packet 5, packet 4, and packet 3, instead of being received in sequential order from packet 1 through packet 6. As shown in FIG. 7, the packets may include UDP packets (e.g., packets 2, 4, and 6) and TCP packets (e.g., packets 1, 3, and 5).

As discussed above in connection with reference number 620 of FIG. 6, the PDCP layer of the UE may select, for each packet of the plurality of packets, between immediate delivery and ordered delivery based at least in part on the one or more packet parameters associated with the packet.

The PDCP layer of the UE may receive packet 1 and select ordered delivery for packet 1. As packet 1 has the lowest sequence number among the plurality of packets, the PDCP layer may determine that the sequence number of packet 1 is not out of sequence, and the PDCP layer may deliver packet 1 to an upper layer of the UE. The PDCP layer may update the PDCP Rx status associated with packet 1 in connection with delivering packet 1.

The PDCP layer of the UE may then receive packet 2 and select immediate delivery for packet 2. The PDCP layer may immediately deliver 2 and update the PDCP Rx status associated with packet 2.

The PDCP layer of the UE may then receive packet 6 and select immediate delivery for packet 6. The PDCP layer may immediately deliver packet 6 and update the PDCP Rx status associated with packet 6, even though packet 6 is received out of order (e.g., the sequence number for packet 6 is out of sequence). In some aspects shown by reference number 704, the PDCP layer may start a reordering timer (e.g., a reordering timer associated with OOD) in connection with a determination that the sequence number for packet 6 is out of sequence.

The PDCP layer of the UE may then receive packet 5 and select ordered delivery for packet 5. The PDCP layer may determine that the sequence number for packet 5 is out of sequence (e.g., packet 5 is received out of order) because packets 3 and 4 have not yet been delivered by the PDCP layer. The PDCP layer may buffer packet 5 in connection with determining the sequence number for packet 5 is out of sequence and selecting ordered delivery for packet 5. In some examples, the PDCP layer may start a reordering timer (e.g., a reordering timer associated with ordered delivery) (shown by reference number 704) in connection with determining the sequence number for packet 5 is out of sequence. In some other examples, the same reordering timer may be used for OOD and ordered delivery, and the reordering timer started in connection with receiving packet 6 may also be applied with respect to packet 5.

The PDCP layer of the UE may then receive packet 4 and select immediate delivery for packet 4. The PDCP layer may immediately deliver packet 4 and update the PDCP Rx status associated with packet 4, even though packet 4 is received out of order (e.g., prior to packet 3). The PDCP layer may be permitted to deliver packet 4 based at least in part on receiving packet 4 prior to the expiration of the reordering timer started in connection with receiving packet 6 (and/or in some examples, the reordering timer started in connection with receiving packet 5).

The PDCP layer of the UE may then receive packet 3 and select ordered delivery for packet 3. The PDCP layer may determine that the sequence number for packet 3 is in sequence because packet 1 and packet 2 have already been delivered by the PDCP layer. The PDCP layer may deliver packet 3 in connection with the determination that the sequence number for packet 3 is in sequence. The PDCP layer may be permitted to deliver packet 3 based at least in part on receiving packet 4 prior to the expiration of the reordering timer started in connection with receiving packet 6 (and/or in some examples, the reordering timer started in connection with receiving packet 5). The PDCP layer may update the PDCP Rx status associated with packet 3 in connection with delivering packet 3. The PDCP layer may then deliver the buffered packet 5 in connection with delivering packets 3 and 4 prior to the expiration of the reordering timer (e.g., the reordering timer started in connection with receiving packet 6 and/or the reordering timer associated with ordered delivery started in connection with receiving packet 5). The PDCP layer may update the PDCP Rx status associated with packet 5 in connection with delivering packet 5.

As shown by reference number 706, the PDCP layer of the UE may deliver the plurality of packets in accordance with the selection of immediate delivery or ordered delivery for each packet. That is, the PDCP layer may deliver packets 2, 4, and 6 (e.g., the UDP packets) using immediate delivery (e.g., OOD), and the PDCP layer may deliver packets 1, 3, and 5 (e.g., the TCP packets) using ordered delivery. As shown in FIG. 7, the UDP packets are delivered out of order with respect to the sequence numbers of the UDP packets, and the TCP packets are delivered in order with respect to the sequence numbers of the TCP packets. The PDCP layer of the UE may deliver the packets to an upper layer of the UE. For example, the PDCP may deliver the packets to one or more data clients (e.g., one or more applications) executing on an upper layer (e.g., an application layer) of the UE. Additionally, or alternatively, the PDCP layer of the UE may deliver (e.g., via an upper layer of UE) the packets to one or more data clients associated with another device, for example in a case in which the UE is serving as an AP or tethered host for the other device.

In example 700 of FIG. 7, and elsewhere in this disclosure, TCP and UDP are used as examples of classes of traffic requiring ordered and immediate delivery, respectively. However, such class of traffic are provided as examples, and it is to be understood that aspects of the subject matter described in this disclosure similarly apply to any other kind of traffic requiring ordered and immediate delivery.

As indicated above, FIG. 7 is provided as an example. Other examples may differ from what is described with respect to FIG. 7.

FIG. 8 is a diagram illustrating an example process 800 performed, for example, at a receiver or an apparatus of a receiver, in accordance with the present disclosure. Example process 800 is an example where the apparatus or the receiver (e.g., UE 120 or network node 110) performs operations associated with PDCP hybrid delivery.

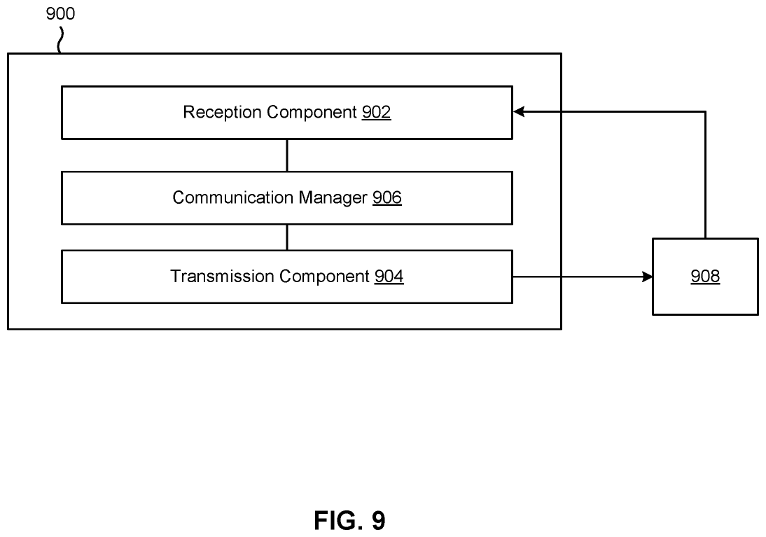

As shown in FIG. 8, in some aspects, process 800 may include receiving, at a PDCP layer of the receiver, PDCP traffic including a plurality of packets associated with a bearer (block 810). For example, the receiver (e.g., using reception component 902 and/or communication manager 906, depicted in FIG. 9) may receive, at a PDCP layer of the receiver, PDCP traffic including a plurality of packets associated with a bearer, as described above.

As further shown in FIG. 8, in some aspects, process 800 may include selecting, for each packet of the plurality of packets, between immediate delivery or ordered delivery based at least in part on one or more packet parameters associated with the packet (block 820). For example, the receiver (e.g., using communication manager 906, depicted in FIG. 9) may select, for each packet of the plurality of packets, between immediate delivery or ordered delivery based at least in part on one or more packet parameters associated with the packet, as described above.

As further shown in FIG. 8, in some aspects, process 800 may include delivering the plurality of packets in accordance with the selection between immediate or ordered delivery for each packet of the plurality of packets (block 830). For example, the receiver (e.g., using communication manager 906, depicted in FIG. 9) may deliver the plurality of packets in accordance with the selection between immediate or ordered delivery for each packet of the plurality of packets, as described above.

Process 800 may include additional aspects, such as any single aspect or any combination of aspects described below and/or in connection with one or more other processes described elsewhere herein.

In a first aspect, selecting between immediate delivery or ordered delivery includes selecting immediate delivery for a packet of the plurality of packets, and delivering the plurality of packets includes updating a PDCP receive status for the packet to indicate that the packet is received, and immediately delivering the packet.

In a second aspect, alone or in combination with the first aspect, a sequence number associated with the packet is out of sequence, and delivering the packet using immediate delivery further includes starting a reordering time associated with out of order delivery.

In a third aspect, alone or in combination with one or more of the first and second aspects, selecting between immediate delivery or ordered delivery includes selecting ordered delivery for a packet of the plurality of packets, and delivering the plurality of packets includes delivering the packet in connection with a determination that a sequence number associated with the packet is in sequence, or buffering the packet and starting a reordering timer associated with ordered delivery in connection with a determination that the sequence number associated with the packet is out of sequence.

In a fourth aspect, alone or in combination with one or more of the first through third aspects, selecting, for each packet of the plurality of packets, between immediate delivery or ordered delivery includes selecting immediate delivery for a first set of packets of the plurality of packets, and selecting ordered delivery for a second set of packets of the plurality of packets.

In a fifth aspect, alone or in combination with one or more of the first through fourth aspects, delivering the plurality of packets includes delivering the first set of packets using immediate delivery, and delivering the second set of packets using ordered delivery.

In a sixth aspect, alone or in combination with one or more of the first through fifth aspects, the plurality of packets are received out of order with respect to sequence numbers associated with the plurality of packets, delivering the first set of packets using immediate delivery includes delivering the first set of packets out of order with respect to sequence numbers associated with the first set of packets, and delivering the second set of packets using ordered delivery includes delivering the second set of packets in order with respect to sequence numbers associated with the second set of packets.

In a seventh aspect, alone or in combination with one or more of the first through sixth aspects, the first set of packets includes at least one of extended reality packets, virtual reality packets, gaming packets, or voice packets.

In an eighth aspect, alone or in combination with one or more of the first through seventh aspects, UDP packets, of the plurality of packets, are included in the first set of packets, and TCP packets, of the plurality of packets, are included in the second set of packets.

In a ninth aspect, alone or in combination with one or more of the first through eighth aspects, the one or more packet parameters associated with the packet include a packet size associated with the packet.

In a tenth aspect, alone or in combination with one or more of the first through ninth aspects, the one or more packet parameters associated with the packet include a type of packet indicated in a packet header associated with the packet.

In an eleventh aspect, alone or in combination with one or more of the first through tenth aspects, the packet header is associated with a higher layer than an SDAP layer.

In an twelfth aspect, alone or in combination with one or more of the first through eleventh aspects, selecting between immediate delivery or ordered delivery includes, for each packet of the plurality of packets, selecting immediate delivery in connection with the packet header associated with the packet indicating that the packet is a UDP packet, or selecting ordered delivery in connection with the packet header associated with the packet indicating that the packet is a TCP packet.

In a thirteenth aspect, alone or in combination with one or more of the first through twelfth aspects, the one or more packet parameters associated with the packet include a parameter indicated in an SDAP header or PDCP header associated with the packet.

In a fourteenth aspect, alone or in combination with one or more of the first through thirteenth aspects, the one or more packet parameters associated with the packet include a packet size and a packet arrival time, and selecting between immediate delivery or ordered delivery includes, for each packet of the plurality of packets, selecting between immediate delivery or ordered delivery based at least in part on the packet size and the packet arrival time using a machine learning model.

In a fifteenth aspect, alone or in combination with one or more of the first through fourteenth aspects, delivering the plurality of packets includes delivering the plurality of packets to an upper layer of the receiver in accordance with the selection between immediate or ordered delivery for each packet of the plurality of packets.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram of an example apparatus 900 for wireless communication, in accordance with the present disclosure. The apparatus 900 may be a receiver (e.g., a UE or a network node), or a receiver may include the apparatus 900. In some aspects, the apparatus 900 includes a reception component 902, a transmission component 904, and/or a communication manager 906, which may be in communication with one another (for example, via one or more buses and/or one or more other components). In some aspects, the communication manager 906 is the communication manager 140 or the communication manager 150 described in connection with FIG. 1. As shown, the apparatus 900 may communicate with another apparatus 908, such as a UE or a network node (such as a CU, a DU, an RU, or a base station), using the reception component 902 and the transmission component 904.

In some aspects, the apparatus 900 may be configured to perform one or more operations described herein in connection with FIGS. 6-7. Additionally, or alternatively, the apparatus 900 may be configured to perform one or more processes described herein, such as process 800 of FIG. 8, or a combination thereof. In some aspects, the apparatus 900 and/or one or more components shown in FIG. 9 may include one or more components of the UE or the network node described in connection with FIG. 2. Additionally, or alternatively, one or more components shown in FIG. 9 may be implemented within one or more components described in connection with FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 902 may receive communications, such as reference signals, control information, data communications, or a combination thereof, from the apparatus 908. The reception component 902 may provide received communications to one or more other components of the apparatus 900. In some aspects, the reception component 902 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 900. In some aspects, the reception component 902 may include one or more antennas, one or more modems, one or more demodulators, one or more MIMO detectors, one or more receive processors, one or more controllers/processors, one or more memories, or a combination thereof, of the UE or the network node described in connection with FIG. 2.

The transmission component 904 may transmit communications, such as reference signals, control information, data communications, or a combination thereof, to the apparatus 908. In some aspects, one or more other components of the apparatus 900 may generate communications and may provide the generated communications to the transmission component 904 for transmission to the apparatus 908. In some aspects, the transmission component 904 may perform signal processing on the generated communications (such as filtering, amplification, modulation, digital-to-analog conversion, multiplexing, interleaving, mapping, or encoding, among other examples), and may transmit the processed signals to the apparatus 908. In some aspects, the transmission component 904 may include one or more antennas, one or more modems, one or more modulators, one or more transmit MIMO processors, one or more transmit processors, one or more controllers/processors, one or more memories, or a combination thereof, of the UE or the network node described in connection with FIG. 2. In some aspects, the transmission component 904 may be co-located with the reception component 902 in one or more transceivers.

The communication manager 906 may support operations of the reception component 902 and/or the transmission component 904. For example, the communication manager 906 may receive information associated with configuring reception of communications by the reception component 902 and/or transmission of communications by the transmission component 904. Additionally, or alternatively, the communication manager 906 may generate and/or provide control information to the reception component 902 and/or the transmission component 904 to control reception and/or transmission of communications.

The reception component 902 may receive, at a PDCP layer of the UE, PDCP traffic including a plurality of packets associated with a bearer. The communication manager 906 may select, for each packet of the plurality of packets, between immediate delivery or ordered delivery based at least in part on one or more packet parameters associated with the packet. The communication manager 906 may deliver the plurality of packets in accordance with the selection between immediate or ordered delivery for each packet of the plurality of packets.

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally, or alternatively, a set of (one or more) components shown in FIG. 9 may perform one or more functions described as being performed by another set of components shown in FIG. 9.

The following provides an overview of some Aspects of the present disclosure:

Aspect 1: A method of wireless communication performed by a receiver, comprising: receiving, at a packet data convergence protocol (PDCP) layer of the receiver, PDCP traffic including a plurality of packets associated with a bearer; selecting, for each packet of the plurality of packets, between immediate delivery or ordered delivery based at least in part on one or more packet parameters associated with the packet; and delivering the plurality of packets in accordance with the selection between immediate or ordered delivery for each packet of the plurality of packets.

Aspect 2: The method of Aspect 1, wherein selecting between immediate delivery or ordered delivery comprises selecting immediate delivery for a packet of the plurality of packets, and wherein delivering the plurality of packets comprises: updating a PDCP receive status for the packet to indicate that the packet is received; and immediately delivering the packet.

Aspect 3: The method of Aspect 2, wherein a sequence number associated with the packet is out of sequence, and wherein delivering the packet using immediate delivery further comprises: starting a reordering time associated with out of order delivery.

Aspect 4: The method of any of Aspects 1-3, wherein selecting between immediate delivery or ordered delivery comprises selecting ordered delivery for a packet of the plurality of packets, and wherein delivering the plurality of packets comprises: delivering the packet in connection with a determination that a sequence number associated with the packet is in sequence; or buffering the packet and starting a reordering timer associated with ordered delivery in connection with a determination that the sequence number associated with the packet is out of sequence.

Aspect 5: The method of any of Aspects 1-4, wherein selecting, for each packet of the plurality of packets, between immediate delivery or ordered delivery comprises: selecting immediate delivery for a first set of packets of the plurality of packets; and selecting ordered delivery for a second set of packets of the plurality of packets.

Aspect 6: The method of Aspect 5, wherein delivering the plurality of packets comprises: delivering the first set of packets using immediate delivery; and delivering the second set of packets using ordered delivery.

Aspect 7: The method of Aspect 6, wherein the plurality of packets are received out of order with respect to sequence numbers associated with the plurality of packets, wherein delivering the first set of packets using immediate delivery comprises delivering the first set of packets out of order with respect to sequence numbers associated with the first set of packets, and wherein delivering the second set of packets using ordered delivery comprises delivering the second set of packets in order with respect to sequence numbers associated with the second set of packets.

Aspect 8: The method of any of Aspects 6-7, wherein the first set of packets includes at least one of extended reality packets, virtual reality packets, gaming packets, or voice packets.

Aspect 9: The method of any of Aspects 6-8, wherein user datagram protocol (UDP) packets, of the plurality of packets, are included in the first set of packets, and wherein transmission control protocol (TCP) packets, of the plurality of packets, are included in the second set of packets.

Aspect 10: The method of any of Aspects 1-9, wherein the one or more packet parameters associated with the packet include a packet size associated with the packet.

Aspect 11: The method of any of Aspects 1-10, wherein the one or more packet parameters associated with the packet include a type of packet indicated in a packet header associated with the packet.

Aspect 12: The method of Aspect 11, wherein the packet header is associated with a higher layer than a service data adaptation protocol (SDAP) layer.

Aspect 13: The method of any of Aspects 11-12, wherein selecting between immediate delivery or ordered delivery comprises, for each packet of the plurality of packets: selecting immediate delivery in connection with the packet header associated with the packet indicating that the packet is a user datagram protocol (UDP) packet; or selecting ordered delivery in connection with the packet header associated with the packet indicating that the packet is a transmission control protocol (TCP) packet.

Aspect 14: The method of any of Aspects 1-13, wherein the one or more packet parameters associated with the packet include a parameter indicated in a service data adaptation protocol (SDAP) header or PDCP header associated with the packet.

Aspect 15: The method of any of Aspects 1-14, wherein the one or more packet parameters associated with the packet include a packet size and a packet arrival time, and wherein selecting between immediate delivery or ordered delivery comprises, for each packet of the plurality of packets: selecting between immediate delivery or ordered delivery based at least in part on the packet size and the packet arrival time using a machine learning model.

Aspect 16: The method of any of Aspects 1-15, wherein delivering the plurality of packets comprises: delivering the plurality of packets to an upper layer of the receiver in accordance with the selection between immediate or ordered delivery for each packet of the plurality of packets.

Aspect 17: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-16.

Aspect 18: An apparatus for wireless communication at a device, the apparatus comprising one or more memories and one or more processors coupled to the one or more memories, the one or more processors configured to cause the device to perform the method of one or more of Aspects 1-16.

Aspect 19: An apparatus for wireless communication, the apparatus comprising at least one means for performing the method of one or more of Aspects 1-16.

Aspect 20: A non-transitory computer-readable medium storing code for wireless communication, the code comprising instructions executable by one or more processors to perform the method of one or more of Aspects 1-16.

Aspect 21: A non-transitory computer-readable medium storing a set of instructions for wireless communication, the set of instructions comprising one or more instructions that, when executed by one or more processors of a device, cause the device to perform the method of one or more of Aspects 1-16.

Aspect 22: A device for wireless communication, the device comprising a processing system that includes one or more processors and one or more memories coupled with the one or more processors, the processing system configured to cause the device to perform the method of one or more of Aspects 1-16.

Aspect 23: An apparatus for wireless communication at a device, the apparatus comprising one or more memories and one or more processors coupled to the one or more memories, the one or more processors individually or collectively configured to cause the device to perform the method of one or more of Aspects 1-16.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or any conventional processor, controller, microcontroller, or state machine. A processor also may be implemented as a combination of computing devices, for example, a combination of a DSP and a microprocessor, a plurality of microprocessors, one or more microprocessors in conjunction with a DSP core, or any other such configuration. In some aspects, particular processes and methods may be performed by circuitry that is specific to a given function.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A receiver for wireless communication, comprising:
one or more memories; and
one or more processors, coupled to the one or more memories, configured to cause the receiver to:
receive, at a packet data convergence protocol (PDCP) layer of the receiver, PDCP traffic including a plurality of packets associated with a bearer;
select, for each packet of the plurality of packets, between immediate delivery or ordered delivery based at least in part on one or more packet parameters associated with the packet; and
deliver the plurality of packets in accordance with the selection between immediate or ordered delivery for each packet of the plurality of packets.

2. The receiver of claim 1, wherein the one or more processors, to cause the receiver to select between immediate delivery or ordered delivery, are configured to cause the receiver to select immediate delivery for a packet of the plurality of packets, and wherein the one or more processors, to cause the receiver to deliver the plurality of packets, are configured to cause the receiver to:
update a PDCP receive status for the packet to indicate that the packet is received; and
immediately deliver the packet.

3. The receiver of claim 2, wherein a sequence number associated with the packet is out of sequence, and wherein the one or more processors, to cause the receiver to deliver the packet using immediate delivery, are further configured to cause the receiver to:
start a reordering time associated with out of order delivery.

4. The receiver of claim 1, wherein the one or more processors, to cause the receiver to select between immediate delivery or ordered delivery, are configured to cause the receiver to select ordered delivery for a packet of the plurality of packets, and wherein the one or more processors, to cause the receiver to deliver the plurality of packets, are configured to cause the receiver to:
deliver the packet in connection with a determination that a sequence number associated with the packet is in sequence; or
buffer the packet and starting a reordering timer associated with ordered delivery in connection with a determination that the sequence number associated with the packet is out of sequence.

5. The receiver of claim 1, wherein the one or more processors, to cause the receiver to select, for each packet of the plurality of packets, between immediate delivery or ordered delivery, are configured to cause the receiver to:
select immediate delivery for a first set of packets of the plurality of packets; and
select ordered delivery for a second set of packets of the plurality of packets.

6. The receiver of claim 5, wherein the one or more processors, to cause the receiver to deliver the plurality of packets, are configured to cause the receiver to:
deliver the first set of packets using immediate delivery; and
deliver the second set of packets using ordered delivery.

7. The receiver of claim 6, wherein the plurality of packets are received out of order with respect to sequence numbers associated with the plurality of packets,
wherein the one or more processors, to cause the receiver to deliver the first set of packets using immediate delivery, are configured to cause the receiver to deliver the first set of packets out of order with respect to sequence numbers associated with the first set of packets, and
wherein the one or more processors, to cause the receiver to deliver the second set of packets using ordered delivery, are configured to cause the receiver to deliver the second set of packets in order with respect to sequence numbers associated with the second set of packets.

8. The receiver of claim 6, wherein the first set of packets includes at least one of extended reality packets, virtual reality packets, gaming packets, or voice packets.

9. The receiver of claim 6, wherein user datagram protocol (UDP) packets, of the plurality of packets, are included in the first set of packets, and wherein transmission control protocol (TCP) packets, of the plurality of packets, are included in the second set of packets.

10. The receiver of claim 1, wherein the one or more packet parameters associated with the packet include a packet size associated with the packet.

11. The receiver of claim 1, wherein the one or more packet parameters associated with the packet include a type of packet indicated in a packet header associated with the packet.

12. The receiver of claim 11, wherein the packet header is associated with a higher layer than a service data adaptation protocol (SDAP) layer.

13. The receiver of claim 11, wherein the one or more processors, to cause the receiver to select between immediate delivery or ordered delivery, are configured to cause the receiver to, for each packet of the plurality of packets:
select immediate delivery in connection with the packet header associated with the packet indicating that the packet is a user datagram protocol (UDP) packet; or
select ordered delivery in connection with the packet header associated with the packet indicating that the packet is a transmission control protocol (TCP) packet.

14. The receiver of claim 1, wherein the one or more packet parameters associated with the packet include a parameter indicated in a service data adaptation protocol (SDAP) header or PDCP header associated with the packet.

15. The receiver of claim 1, wherein the one or more packet parameters associated with the packet include a packet size and a packet arrival time, and wherein the one or more processors, to cause the receiver to select between immediate delivery or ordered delivery, are configured to cause the receiver to, for each packet of the plurality of packets:
select between immediate delivery or ordered delivery based at least in part on the packet size and the packet arrival time using a machine learning model.

16. The receiver of claim 1, wherein the one or more processors, to cause the receiver to deliver the plurality of packets, are configured to cause the receiver to:
deliver the plurality of packets to an upper layer of the receiver in accordance with the selection between immediate or ordered delivery for each packet of the plurality of packets.

17. A method of wireless communication performed by a receiver, comprising:
receiving, at a packet data convergence protocol (PDCP) layer of the receiver, PDCP traffic including a plurality of packets associated with a bearer;
selecting, for each packet of the plurality of packets, between immediate delivery or ordered delivery based at least in part on one or more packet parameters associated with the packet; and
delivering the plurality of packets in accordance with the selection between immediate or ordered delivery for each packet of the plurality of packets.

18. The method of claim 17, wherein selecting between immediate delivery or ordered delivery comprises selecting immediate delivery for a packet of the plurality of packets, and wherein delivering the plurality of packets comprises:
updating a PDCP receive status for the packet to indicate that the packet is received; and
immediately delivering the packet.

19. The method of claim 18, wherein a sequence number associated with the packet is out of sequence, and wherein delivering the packet using immediate delivery further comprises:
starting a reordering time associated with out of order delivery.

20. The method of claim 17, wherein selecting between immediate delivery or ordered delivery comprises selecting ordered delivery for a packet of the plurality of packets, and wherein delivering the plurality of packets comprises:
delivering the packet in connection with a determination that a sequence number associated with the packet is in sequence; or
buffering the packet and starting a reordering timer associated with ordered delivery in connection with a determination that the sequence number associated with the packet is out of sequence.

21. The method of claim 17, wherein selecting, for each packet of the plurality of packets, between immediate delivery or ordered delivery comprises:
selecting immediate delivery for a first set of packets of the plurality of packets; and
selecting ordered delivery for a second set of packets of the plurality of packets.

22. The method of claim 21, wherein delivering the plurality of packets comprises:
delivering the first set of packets using immediate delivery; and
delivering the second set of packets using ordered delivery.

23. The method of claim 22, wherein the plurality of packets are received out of order with respect to sequence numbers associated with the plurality of packets,
wherein delivering the first set of packets using immediate delivery comprises delivering the first set of packets out of order with respect to sequence numbers associated with the first set of packets, and
wherein delivering the second set of packets using ordered delivery comprises delivering the second set of packets in order with respect to sequence numbers associated with the second set of packets.

24. The method of claim 17, wherein the one or more packet parameters associated with the packet include a packet size associated with the packet.

25. The method of claim 17, wherein the one or more packet parameters associated with the packet include a type of packet indicated in a packet header associated with the packet.

26. The method of claim 25, wherein selecting between immediate delivery or ordered delivery comprises, for each packet of the plurality of packets:
selecting immediate delivery in connection with the packet header associated with the packet indicating that the packet is a user datagram protocol (UDP) packet; or
selecting ordered delivery in connection with the packet header associated with the packet indicating that the packet is a transmission control protocol (TCP) packet.

27. The method of claim 17, wherein the one or more packet parameters associated with the packet include a parameter indicated in a service data adaptation protocol (SDAP) header or PDCP header associated with the packet.

28. The method of claim 17, wherein the one or more packet parameters associated with the packet include a packet size and a packet arrival time, and wherein selecting between immediate delivery or ordered delivery comprises, for each packet of the plurality of packets:
selecting between immediate delivery or ordered delivery based at least in part on the packet size and the packet arrival time using a machine learning model.

29. A non-transitory computer-readable medium storing a set of instructions for wireless communication, the set of instructions comprising:
one or more instructions that, when executed by one or more processors of a receiver, cause the receiver to:
receive, at a packet data convergence protocol (PDCP) layer of the receiver, PDCP traffic including a plurality of packets associated with a bearer;
select, for each packet of the plurality of packets, between immediate delivery or ordered delivery based at least in part on one or more packet parameters associated with the packet; and
deliver the plurality of packets in accordance with the selection between immediate or ordered delivery for each packet of the plurality of packets.

30. An apparatus for wireless communication, comprising:
means for receiving, at a packet data convergence protocol (PDCP) layer of the apparatus, PDCP traffic including a plurality of packets associated with a bearer;
means for selecting, for each packet of the plurality of packets, between immediate delivery or ordered delivery based at least in part on one or more packet parameters associated with the packet; and
means for delivering the plurality of packets in accordance with the selection between immediate or ordered delivery for each packet of the plurality of packets.
